(19) United States
(12) Patent Application Publication
(10) Pub. No.: US 2006/0141085 A1
(43) Pub. Date: Jun. 29, 2006

(54) Melt blow head

(75) Inventors: Axel Nickel, Glattbach (DE); Wolfgang Rohm, Grossostheim (DE)

Correspondence Address: BANNER & WITCOFF, 1001 G STREET N W, SUITE 1100, WASHINGTON, DC, 20001, US

(73) Assignee: Rieter Automatik GMBH, Grossostheim (DE)

(21) Appl. No.: 10/538,651

(22) PCT Filed: Dec. 8, 2003
(86) PCT No.: PCT/EP03/13900

§ 371 Date: Nov. 30, 2005

(30) Foreign Application Priority Data
Dec. 12, 2002 (DE) 102 58 170.3

(51) Int. Cl. B28B 5/00

(52) U.S. Cl. 425/72.2

(57) ABSTRACT

The invention relates to a melt-blow head with a rectilinear row of nozzle bores arranged in a nozzle bar, said nozzle bores serving to produce endless filaments formed from a melt, said nozzle bores being associated with blowing slots, in the form of longitudinal slots, of two slot-plates for feeding blowing air at an angle to the nozzle bores and to which nozzle bores the melt is fed through one or more distributors in the melt-blow head, the distributor(s) being supplied with the melt through a feeding pipe. The feeding pipe in the melt-blow head leads from a lateral inlet via a redirecting means in an essentially vertical direction to the distributor, said inlet being connected to a melt pipe through a removable connector, the nozzle bar being fixed in a defined position with respect to the slot-plates and being removable therefrom in an approximately vertical direction.

The invention relates to a melt-blow head with a rectilinear row of nozzle bores arranged in a nozzle bar, said nozzle bores serving to produce endless filaments formed from a melt, said nozzle bores being associated with blowing slots, in the form of longitudinal slots, of two slot-plates for feeding blowing air at an angle to the nozzle bores and to which nozzle bores the melt is fed through one or more distributors in the melt-blow head, the distributor(s) being supplied with the melt through a feeding pipe.

Such a melt-blow head is described and presented in European patent specification 0 625 939 B1 (see DE 693 19 582 T2). The known device serves to produce a tangle of filaments on a revolving belt from the endless filaments given off by the device, it then being possible for the said tangle of filaments to be used as a known nonwoven fabric. The hereinbelow-described melt-blow head according to the invention can advantageously be used in the same manner. In the known device, by screwing to the slot-plates the nozzle bar forms one unit which can be removed in the longitudinal direction from a housing for the purpose of cleaning or maintenance. The endless filaments are pressed out of the melt-blow head in a vertical direction and then, after passing through a cooling section, are deposited on a conveyor belt in a tangle, said conveyor belt carrying away the formation of tangled endless filaments in the form of a nonwoven fabric. The melt required for production of the endless filaments is introduced vertically from above through the housing into the melt-blow head; the blow air is fed in from both sides via air chambers, from where the blow air is then directed to the blowing slots. The lateral removal of the melt-blow head from the housing is due to the fact that the feed for the melt projects vertically upwards out of the housing. The removal of the melt-blow head in the direction of the row of nozzle bores requires considerable space equivalent at least to the length of the melt-blow head. This is often a problem for reasons of integration of such an arrangement for the production of a nonwoven fabric, because, for structural reasons, such space cannot readily be made available.

The object of the invention is to improve the adaptability of the melt-blow head to the surroundings for the purpose of the maintenance or cleaning of the melt-blow head. The object of the invention is achieved in that the feeding pipe in the melt-blow head leads from a lateral inlet via a redirecting means in an essentially vertical direction to the distributor, said inlet being connected to a melt pipe through a removable connector, the nozzle bar being fixed in a defined position with respect to the slot-plates and being removable therefrom in an approximately vertical direction.

As a consequence of the redirecting of the feeding pipe for the melt in the nozzle bar, according to which the melt is fed in the nozzle bar from a lateral inlet via the redirecting means in an essentially vertical direction to the distributor, the space above the nozzle bar is kept free of feeding pipes, with the result that the nozzle bar can be lifted vertically off the slot-plates, for which purpose the nozzle bar is removably fixed on the slot-plates. The space above the nozzle bar is generally free of any components or arrangement parts, with the consequence that the vertical removability of the nozzle bar results in problem-free cleaning and/or maintenance.

In the design of the melt-blow head according to the invention, it is additionally possible to achieve the automatic aligning of the nozzle bar with respect to the slot-plates in that the nozzle bar is laterally enclosed by air feed blocks with horizontal and vertical walls, said air feed blocks being arranged parallel to the row of nozzle bores, said air feed blocks being contacted by the nozzle bar with a step with horizontal and vertical legs, a slot-plate being in contact with each air feed block against a stop and leaving open a space with respect to the air feed block for supplying the blow air to the longitudinal slots.

Owing to the fact that the two legs of the step are each in positive form-fitting contact with an air feed block, the nozzle bar is precisely held with regard to its position in the vertical and horizontal directions, the partial contacting of each slot-plate with an air feed block against a stop meaning that its position is also precisely maintained. When nozzle bar and slot-plates are taken apart and subsequently reassembled, both nozzle bar and slot-plates are returned to their respective positions of precise alignment with respect to each other, with the consequence that, during such reassembly operation, there is no need for special adjustment with respect to the nozzle bar. This precise positioning is of decisive importance for the correct functioning of the melt-blow head.

In order to stop the further inflow of the melt when the nozzle bar is removed from the slot-plates, the melt pipe is advantageously provided in the region of the connector with a shut-off valve.

So that, when the nozzle block is lifted off, the removed melt pipe does not obstruct this operation, it is advantageous for the melt pipe to be movable with its connector, with the latter removed, in relation to the inlet. It is also possible, instead of the special movability of the melt pipe, to provide the connector with a deformable seal which provides, within the range of the deformability thereof, a space between connector and inlet, as a result of which the nozzle bar can be lifted off the melt pipe without obstruction.

Experience shows that air vortices are formed behind the blowing slots in the direction of the blow air stream, said air vortices possibly leading under certain circumstances to early collision of the individual endless filaments and thus to the sticking-together thereof. In order to prevent this by means of evening out the air stream, the side of the slot-plates opposite the nozzle bar is advantageously in the form of a concave rounded section, this guaranteeing the extensive absence of turbulence in the ambient air which is entrained with the blow air.

Example embodiments of the invention are presented in the drawings, in which:

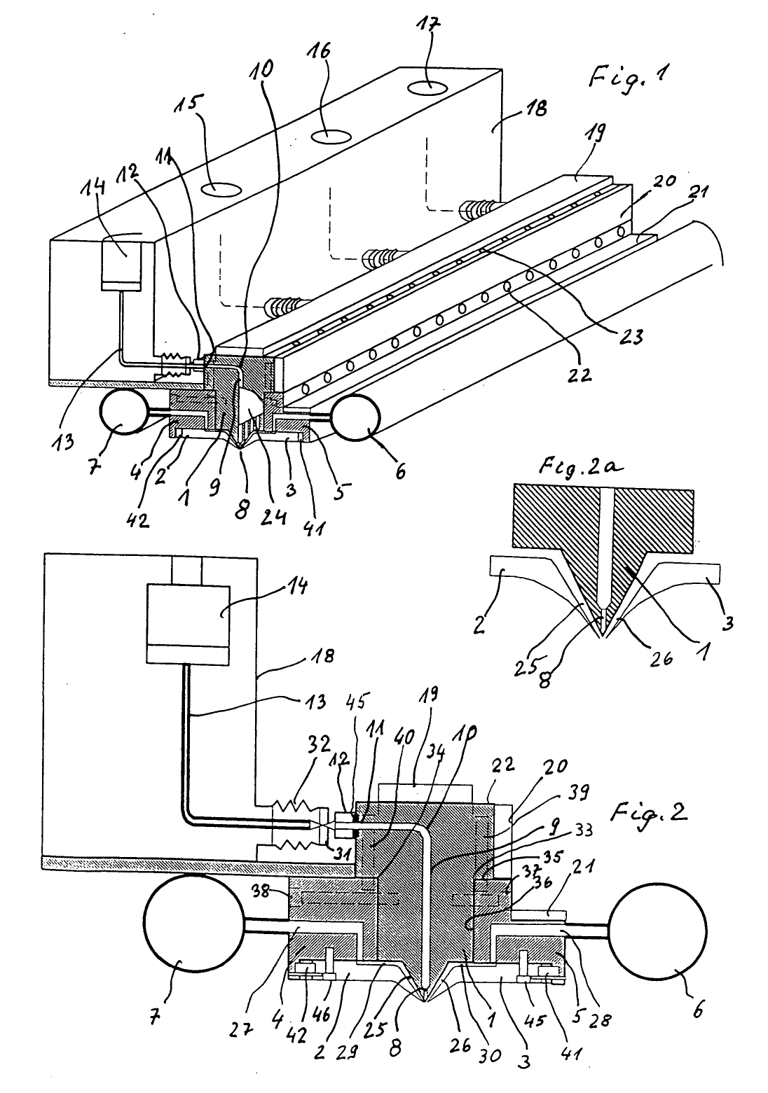

FIG. 1 shows the melt-blow head with heating box in a perspective view;

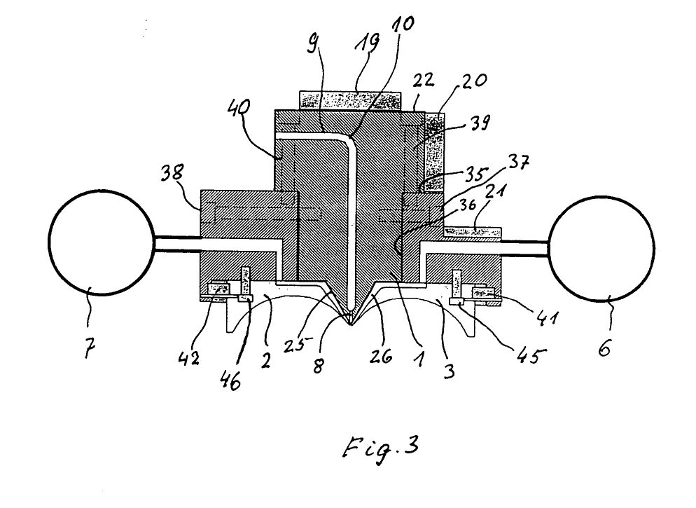

FIG. 2 shows the same arrangement in a side view in section;

FIG. 2a shows the region of the longitudinal slots 25 and 26 from FIG. 2 in an enlarged representation;

FIG. 3 shows the arrangement from FIG. 2 with rounded slot-plates.

FIG. 1 shows a melt-blow head with the nozzle bar 1 and two slot-plates 2 and 3, this being in the form of a perspective view, said melt-blow head being enclosed laterally by the air feed blocks 4 and 5. The nozzle bar 1 (shown here as being of one-piece design) may also be composed of two or more parts to form a block. The two air feed blocks 4 and 5 are supplied in known manner by the two air pipes 6 and 7. For the supply of blowing air, the slot-plates 2 and 3 form longitudinal slots, extending over the length of the nozzle bar, next to the nozzle bores 8; this will be discussed in greater detail in connection with FIG. 2.

Extending in the nozzle bar 1 for the feeding of the melt is the feeding pipe 9, which leads via the redirecting means 10 to the inlet 11 in the nozzle bar, where the connection to the melt pipe 13 is made via the connector 12. As already noted previously, such nozzle bars usually consist of two or more plates or parts. According to FIG. 1, the arrangement shown has four melt pumps 14, 15, 16 and 17, which, as presented in connection with the melt pipe 13, ensure the supply of the respective nozzle bores in the nozzle bar 1. The melt pumps 14, 15, 16 and 17 and the associated melt pipes 13 are accommodated in the heating box 18, in which the therein contained melt is held at melting temperature.

Further shown in FIG. 1 are heating plates 19, 20 and 21, which will be discussed in greater detail in connection with FIG. 2. FIG. 1 additionally shows the heads 22 and 23 of a row of screws, which will likewise be discussed in greater detail in connection with FIG. 2.

FIG. 2 presents a sectional representation of the arrangement according to FIG. 1 viewed from the side. The nozzle bar 1 forms a block containing the feeding pipe 9 and the redirecting means 10, in which block the supplied melt is divided up between the individual nozzle bores 8 by the distributor 24 (see FIG. 1) in the nozzle bar 1.

The design of the end of the nozzle bore 8 and of the adjoining ends of the slot-plates 2 and 3 is shown in FIG. 2a, which presents an enlarged view of the corresponding part from FIG. 2.

The two slot-plates 2 and 3 each leave open a longitudinal slot 25 and 26 with respect to the end of the nozzle bore 8, from which slot blowing air flows out, cooling and carrying away the melt escaping from the nozzle bore 8. The longitudinal slots 25 and 26 are supplied with blowing air from the air pipes 6 and 7 via the pipes 27 and 28, which pipes extend inside the air feed blocks 4 and 5 and which terminate in spaces 29 and 30 between the slot-plates 2 and 3, on the one side, and the nozzle bar 1 and the air feed blocks 4 and 5.

The above-described design and effect of the end of the nozzle bore 8 with the longitudinal slots 25 and 26 is known and is presented in principle in the initially mentioned publication.

The feeding pipe 9 leads via the redirecting means 10 to the lateral inlet 11, which is connected to the connector 12, which has a deformable seal 45. Positioned in front of the connector 12 is the shut-off valve 31, the purpose of which is to prevent further melt from flowing out of the melt pump 14 when the nozzle bar 1 is removed in the below-described manner. At the end of the melt pipe 13, the latter leads through the bellows 32, which ensures that there can be a certain flexibility between the connector 12 and the melt pipe 13.

The nozzle bar 1 has the steps 33 and 34, each of which have a horizontal and a vertical leg 35, 36 (drawn only with reference character in connection with the step 33). Said legs 35 and 36 are in contact with corresponding wall parts of the air feed blocks 4 and 5, which extend horizontally and vertically and therefore permit the fitting in of the steps 33 and 34. The connection of the nozzle bar 1 to the air feed blocks 4 and 5 is by means of the horizontal screws 37 and 38 (for horizontal screws 37 with the screw heads 22 see FIG. 1) and the vertical screws 39 and 40 (for screw heads 23 of the vertical screws 39 according to FIG. 1). When these screws are tightened, this results in a solid unit including the nozzle bar 1 and the two slot-plates 2 and 3, this guaranteeing the precise alignment of the nozzle bore 8 to the slots 25 and 26. The slot-plates 2 and 3 are given a particular orientation in the direction of the nozzle bore 8 in that, with their ends opposite the longitudinal slots 2 and 3, the slot-plates 2 and 3 come up against the insertable spacers 41 and 42, which are variable in their thickness and which form a limit stop, and are secured against said spacers 41 and 42 by means of the screws 43, 44. The pressing of the slot-plates 2 and 3 against the air feed blocks 4 and 5 is accomplished by means of the screws 45 and 46.

If the nozzle bar 1 needs to be removed for any reason, e.g. for cleaning and maintenance, then it is necessary to remove the horizontal screws 37 and 38 and the vertical screws 39 and 40 and to disconnect the connector 12, as a consequence of which the nozzle bar 1 can be lifted off upwardly from the slot-plates 2 and 3 and removed from the arrangement. The nozzle bar 1 is re-inserted in the opposite direction, it being necessary merely to slide the nozzle bar 1 between the two air feed blocks 4 and 5 and to re-insert and tighten the previously removed screws, the nozzle bar 1 assuming a position defined by the steps 33 and 34. If, for example, the air feed block 4 has a position defined by a further external structural unit, this results for the further components of the unit, consisting of nozzle bar 1, air feed block 5 and slot-plates 2 and 3, in a self-contained defined position, with the consequence that there is no subsequent need for the special adjustment of the nozzle bores 8 in relation to the longitudinal slots 25 and 26.

A further advantage of the design of the arrangement as shown in FIG. 2 consists in the fact that the screws 37, 38, 39 and 40 necessary for the taking apart and assembling of the aforementioned unit require the respective screws to be brought to the unit merely from the side and from above, where there is normally sufficient space for turning the screws.

FIG. 2 shows the heating plates 19, 20 and 21 already mentioned in connection with the Figure, said heating plates providing for the required heating of the nozzle bar 1 with the air feed blocks 4 and 5.

FIG. 3 shows an arrangement which, with the exception of the design of the slot-plates, is completely identical to the arrangement shown in FIG. 2. The slot-plates 45 and 46 shown in FIG. 3 are provided on their sides opposite the air feed blocks 4 and 5 and the nozzle bar 1 with a concave rounded section, with the result that passing air from the surrounding environment is entrained uniformly and extensively without turbulence by the air streams escaping from the longitudinal slots 25 and 26, this extensively preventing any swirling of the endless filaments escaping from the nozzle bores 8.

1. A melt-blow head comprising:
a rectilinear row of nozzle bores arranged in a nozzle bar, the nozzle bores configured to produce endless filaments formed from a melt and associated with blowing slots in the form of longitudinal slots of two slot-plates for feeding blowing air at an angle to the nozzle bores to which the melt is fed through a distributor, wherein the nozzle bar is fixed in a defined position with respect to the slot-plates and removable therefrom in a vertical direction;
the distributor supplied with the melt through a feeding pipe;
the feeding pipe leading from a lateral inlet via a redirecting means in a vertical direction to the distributors; and
the inlet connected to a melt pipe through a removable connector.

2. A melt-blow head according to claim 1, wherein the nozzle bar is laterally enclosed by air feed blocks with horizontal and vertical walls, said air feed blocks being arranged parallel to the row of nozzle bores and contacted by the nozzle bar with a step with horizontal and vertical legs, a slot-plate in contact with each air feed block against a stop leaving open a space with respect to the air feed block for supplying the blow air to the longitudinal slots.

3. A melt-blow head according to claim 1, wherein the melt pipe is provided in the region of the connector with a shut-off valve.

4. A melt-blow head according to claim 1, wherein the melt pipe is movable with its connector, with the latter removed, in relation to the inlet.

5. A melt-blow head according to claim 1, wherein the connector has a deformable seal.

6. A melt-blow head according to claim 1, wherein the slot-plates extend in a concave rounded section on a side opposite the nozzle bar.

7. A melt-blow head according to claim 1, further comprising a second distributor.

8. A melt-blow head according to claim 7, wherein melt is fed through the second distributor.

9. A melt-blow head according to claim 2, wherein the melt pipe is provided in the region of the connector with a shut-off valve.

10. A melt-blow head according to claim 2, wherein the melt pipe is movable with its connector, with the latter removed, in relation to the inlet.

11. A melt-blow head according to claim 2, wherein the connector has a deformable seal.

12. A melt-blow head according to claim 2, wherein the slot-plates extend in a concave rounded section on a side opposite the nozzle bar.

13. A melt-blow head according to claim 3, wherein the connector has a deformable seal.

14. A melt-blow head according to claim 3, wherein the melt pipe is movable with its connector, with the latter removed, in relation to the inlet.

15. A melt-blow head according to claim 3, wherein the slot-plates extend in a concave rounded section on a side opposite the nozzle bar.

16. A melt-blow head according to claim 4, wherein the slot-plates extend in a concave rounded section on a side opposite the nozzle bar.

17. A melt-blow head according to claim 5, wherein the slot-plates extend in a concave rounded section on a side opposite the nozzle bar.
